(19) United States
(12) Patent Application Publication
(10) Pub. No.: US 2010/0080334 A1
(43) Pub. Date: Apr. 1, 2010

(54) METHOD AND APPARATUS FOR VERIFYING PERFORMANCE OF CONTROL SYSTEM OF NUCLEAR POWER PLANT

(75) Inventors: Suk Whun SOHN, Daejeon (KR); In Ho SONG, Daejeon (KR); See Chae JEONG, Daejeon (KR); Ung Soo KIM, Daejeon (KR); Myung Jun SONG, Daejeon (KR); Jong Joo SOHN, Daejeon (KR); Eun Kee KIM, Daejeon (KR)

Correspondence Address: Jason Y. Pahng and Associates, LLC, 12178 Bridgend Run, Fairfax, VA, 22030, US

(73) Assignee: KOREA POWER ENGINEERING COMPANY, INC., Yongin (KR)

(21) Appl. No.: 12/250,543

(22) Filed: Oct. 14, 2008

(30) Foreign Application Priority Data
Sep. 30, 2008 (KR) 10-2008-0096214

(51) Int. Cl. G21C 7/36

(52) U.S. Cl. 376/217

(57) ABSTRACT

Provided are a method and apparatus for validating dynamic performance of a control system of a nuclear power plant in operation, without performing a power ascension test. According to the present invention, when the performance of the control system requires to be validated in order to change a control logic or its setpoint of or to replace hardware of the control system, the dynamic performance of the control system may be validated without performing the power ascension test which can be performed only in a trial operation and requires large expenses. In the present invention, a design computer code capable of simulating a transient state of the nuclear power plant is connected to the hardware of the control system, and tests to be performed at the power ascension test or in the transient state of the nuclear power plant are simulated by directly using the hardware of the control system instead of a control system model of the design computer code, in an on-line state.

### CROSS-REFERENCE TO RELATED PATENT APPLICATION

This application claims the benefit of Korean Patent Application No. 10-2008-0096214, filed on Sep. 30, 2008, in the Korean Intellectual Property Office, the disclosure of which is incorporated herein in its entirety by reference.

### BACKGROUND OF THE INVENTION

1. Field of the Invention

The present invention relates to a method and apparatus for validating performance of a control system of a nuclear power plant with regard to a dynamic change such as a change into a transient state, without performing a power ascension test when the performance of the control system requires to be validated in order to change a control logic of or to replace old hardware of the control system of the nuclear power plant in operation, or when the performance of the control system requires to be previously validated before performing the power ascension test of a newly built nuclear power plant.

2. Description of the Related Art

A nuclear power plant has a large number of control systems and control devices and safely and efficiently operates in a steady or transient state by help of the control system and the control devices. Performance of a control system or control device is checked and validated through a power ascension test during a trial operation before a commercial operation of the nuclear power plant.

Conventionally, in a newly build nuclear power plant, performance of the control system has been validated by sequentially performing three processes; (1) a process of validating whether a control logic and its setpoint of the control system can appropriately stabilize a transient state of the nuclear power plant by using a design computer code and by analyzing transient states that can occur to the nuclear power plant in an off-line state, (2) a process of filtering software errors occurring when software is produced, by setting the control logic and its setpoint to the produced software and performing a static performance test such as a field acceptance test (FAT) or a pre-operational test, and (3) a process of performing a dynamic performance test so as to check whether the control system appropriately operates to stabilize the nuclear power plant as designed, by actually causing a transient state through the power ascension test that is performed during the trial operation.

When the validation is performed by using the design computer code, hardware characteristics are not reflected because the design computer code models the control system regardless of certain hardware. Thus, only the control logic and its setpoint can be validated and human errors that can occur when the hardware of the control system is replaced or when the software of the control system is written, are not possible to be validated.

In order to supplement the above problem, the static performance test is performed after the hardware is produced. The static performance test previously expects result values to be output when an input signal is provided to the control system and manually checks whether the expected result values are output when a simulated signal is actually provided to the control system as the input signal. However, the static performance test cannot validate response characteristics of the control system with regard to a dynamic change such as a change into the transient state of the nuclear power plant.

Accordingly, all errors occurring when the hardware is produced or the software is written cannot be completely detected by performing only the static performance test. Although the validation using the design computer code and the static performance test can be supplemented in a newly built nuclear power plant by lastly checking dynamic performance of the control system through the power ascension test before the commercial operation, the performance of the control system, which is checked and validated as described above, can be changed if the control logic or its setpoint is changed or the hardware of the control system is replaced during the commercial operation. In this case, it should be validated that a new control logic to be changed into or new hardware to be replaced with will not cause the transient state during the commercial operation when objective validation is performed on the new control logic or the new hardware, before the control logic is changed or the hardware of the control system is replaced.

When the control logic is changed or the hardware of the control system is replaced during the commercial operation of the nuclear power plant, the most accurate method of validating the performance of the control system is to follow processes of the method that is used in the newly built nuclear power plant. First, the new control logic or its setpoint is substituted in the design computer code that is adjusted and optimized so as to have the same response characteristics as the trial operation, and the transient states of the nuclear power plant are simulated so as to check errors and defects. If the hardware is to be replaced, after the validation is performed by using the design computer code, the static performance test such as the FAT or the pre-operational test is performed by a hardware producer. Second, the dynamic performance test is performed through the power ascension test. However, in consideration of economic losses due to human resource required for and electric power reduction caused by the power ascension test, and influences of the transient state on devices in the nuclear power plant, the dynamic performance test through the power ascension test is not actually possible to be performed by changing powers. As such, unlike a newly built nuclear power plant, the dynamic performance test is not actually possible to be performed in a nuclear power plant in operation, and thus, although the hardware of the control system is worn so as to have a high possibility to be broken, the control system cannot be easily replaced.

### SUMMARY OF THE INVENTION

The present invention provides a method and apparatus for validating dynamic performance of a control system of a nuclear power plant by simulating a power ascension test instead of actually performing the power ascension test when a control logic of the control system is changed or hardware of the control system is replaced in the nuclear power plant in operation.

According to an aspect of the present invention, there is provided an apparatus for validating dynamic performance of a control system of a nuclear power plant by directly connecting control system hardware under validation in an on-line state. In addition to an existing design computer code of the nuclear power plant, the apparatus includes an interface program providing an input signal required for operation to the control system hardware under validation and receiving an output signal of the control system hardware under validation so as to provide the output signal to the design computer code, and a graphic user interface (GUI) interfacing with the control system hardware under validation.

According to another aspect of the present invention, there is provided a method of validating dynamic performance of a control system of a nuclear power plant by directly connecting a design computer code capable of simulating a transient state of the nuclear power plant to control system hardware under validation, and simulating the transient state of the nuclear power plant using the control system hardware under validation in an on-line state, instead of using the design computer code in an off-line state. As such, dynamic performance validation that was performed only through a power ascension test may be improved.

### BRIEF DESCRIPTION OF THE DRAWINGS

The above and other features and advantages of the present invention will become more apparent by describing in detail exemplary embodiments thereof with reference to the attached drawings in which:

FIG. 1 is a structural diagram of a control system performance validation apparatus according to an embodiment of the present invention;

FIG. 2 is a schematic flowchart of a control system performance validation method according to an embodiment of the present invention;

FIG. 3 is a functional structural diagram of an interface program according to an embodiment of the present invention;

FIGS. 4A and 4B are graphs showing results of performance validation tests performed when in load rejection, according to an embodiment of the present invention;

FIGS. 5A and 5B are graphs showing results of performance validation tests performed when in loss of a main feedwater pump, according to an embodiment of the present invention;

FIGS. 6A and 6B are graphs showing results of performance validation tests performed when in reactor trip, according to an embodiment of the present invention; and

FIG. 7 is a structural diagram of a control system performance validation apparatus in relation to a control device, according to another embodiment of the present invention.

### DETAILED DESCRIPTION OF THE INVENTION

Hereinafter, the present invention will be described in detail by explaining embodiments of the invention with reference to the attached drawings.

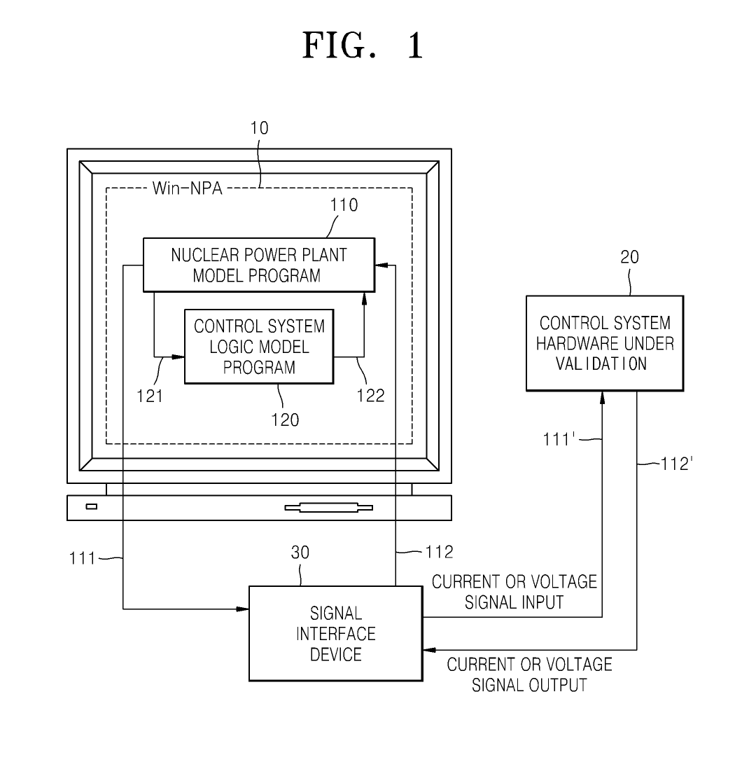

FIG. 1 is a structural diagram of a control system performance validation apparatus according to an embodiment of the present invention.

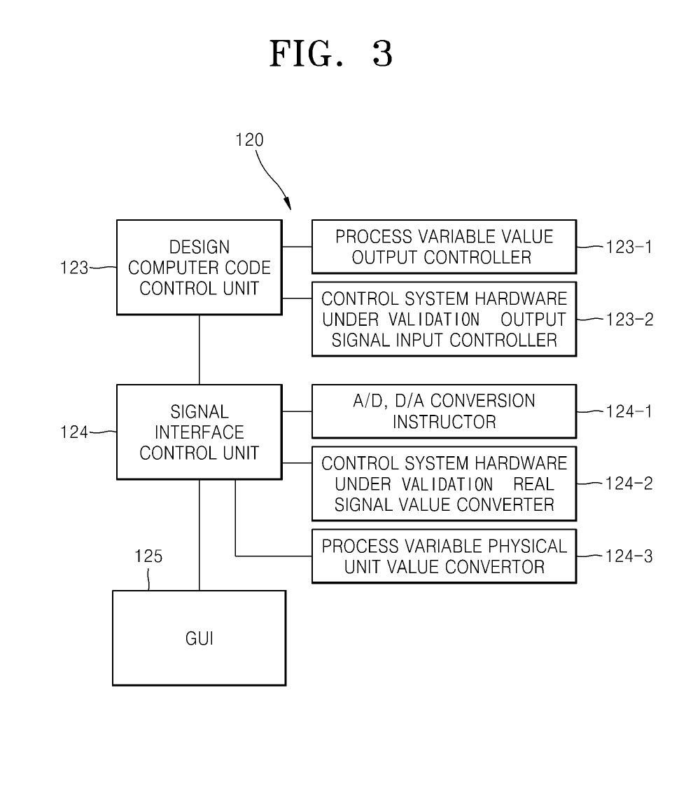

Referring to FIG. 1, the control system performance validation apparatus operates by using an interface program (not shown) for controlling inputs and outputs related to a control system under validation from and to an existing design computer code of a nuclear power plant. A signal output from the design computer code is input to a control system hardware under validation 20 through a signal interface device 30 and a signal output from the control system hardware under validation 20 is input to the design computer code through the signal interface device 30. The design computer code and the interface program may be installed in a computer so as to be used. In FIG. 1, the control system performance validation apparatus corresponds to a Win-NPA 10 that is a trademark name of a program that has been developed by employing the interface program and a graphic user interface (GUI) in addition to the design computer code. Although not shown in FIG. 1, a detailed structure of the interface program is illustrated in FIG. 3.

The design computer code is a well-known program and refers to both an existing nuclear power plant model program 110 and a control system logic model program 120.

Due to the control of the interface program, a simulation signal simulating the nuclear power plant is provided to the control system hardware under validation 20 and an output signal of the control system hardware under validation 20 is reflected to the simulating of the nuclear power plant by the design computer code. Thus, a power ascension test of the nuclear power plant may be simulated. Transient states of the nuclear power plant are simulated before and after a new control logic or its setpoint is set or a new control system hardware is installed, and simulation results are compared to each other so as to check influences of the new control logic or its setpoint on a control system that is already validated, or to compare performance of the new control system hardware to the performance of the control system hardware under validation 20.

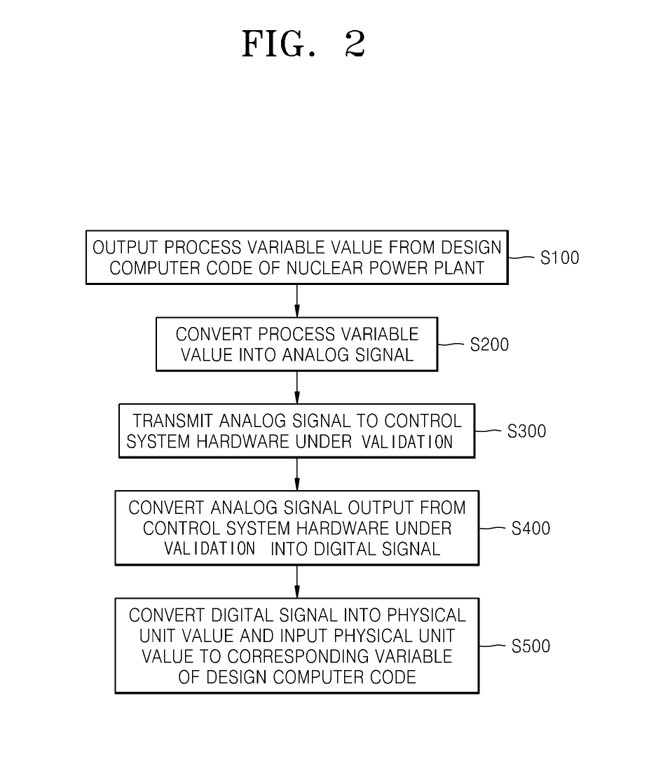

FIG. 2 is a schematic flowchart of a control system performance validation method according to an embodiment of the present invention. In general, the control system performance validation method is performed by the control of an interface program. FIG. 2 will be described in conjunction with FIG. 1.

Referring to FIG. 2, initially, a process variable value 111 is output from the design computer code of the nuclear power plant in operation S100. The process variable value 111 is converted into an analog process variable signal 111′ in operation S200. The converting of the process variable value 111 is performed by the signal interface device 30. Then, the analog process variable signal 111′ is transmitted to the control system hardware under validation 20 in operation S300. Meanwhile, the control system hardware under validation 20 receives the analog process variable signal 111′ so as to perform a predetermined operation, and outputs an analog output signal 112′ to the signal interface device 30, and the signal interface device 30 converts the analog output signal 112′ into a digital signal, in operation S400. The signal interface device 30 converts the digital signal into a physical unit value 112 and inputs the physical unit value 112 to a corresponding variable of the design computer code, in operation S500.

As described above with reference to FIG. 1, the Win-N PA 10 has been developed by employing the interface program and a GUI in addition to the design computer code that refers to both the nuclear power plant model program 110 and the control system logic model program 120. The Win-NPA 10 provides a simulation signal simulating the nuclear power plant to the control system hardware under validation 20. Here, the design computer code has, for example, a reactor core model, a thermal-hydraulics model, a control algorithm model, and a constructional device model such as a pump and a valve, and is used to design the nuclear power plant.

FIG. 3 is a functional structural diagram of an interface program according to an embodiment of the present invention. FIG. 3 will be described in conjunction with FIG. 1.

Referring to FIG. 3, the interface program according to the current embodiment of the present invention includes a design computer code control unit 123, a signal interface control unit 124, and a GUI 125.

The design computer code control unit 123 controls the design computer code of the nuclear power plant, and includes a process variable value output controller 123-1 and a control system hardware under validation output signal input controller 123-2. Process variables such as pressure, flowing rate, temperature, and water level variables which are simulated and calculated by the design computer code are calculated in physical unit values. The process variable value output controller 123-1 controls the design computer code to output the process variable values. The control system hardware under validation output signal input controller 123-2 receives an analog signal (0˜10 Vdc or 4˜20 mA) as a digital value through the signal interface device 30, converts the digital value into a physical unit value, and inputs the physical unit value to a corresponding variable of the nuclear power plant model program 110.

The signal interface control unit 124 consists of an analog-to-digital (A/D), digital-to-analog (D/A) conversion instructor 124-1 instructing the signal interface device 30 to perform A/D or D/A conversion, a control system hardware under validation real signal value converter 124-2 converting the process variable values in the physical unit values into real signal values of the control system hardware under validation 20, and a process variable physical unit value convertor 124-3 converting the real signal values of the control system hardware under validation 20 into the physical unit values of the process variable values of the nuclear power plant model program 110.

The GUI 125 is used to manipulate constructional devices that are modeled in the design computer code, such as a pump, a valve, and an electric heater. For example, the GUI 125 may manually control opening of the valve.

Referring back to FIG. 1, the signal interface device 30 includes an analog-to-digital converter (ADC) and a digital-to-analog converter (DAC), converts a digital signal output from the Win-N PA 10 into an analog signal so as to provide the analog signal to the control system hardware under validation 20, and converts an analog signal output from the control system hardware under validation 20 into a digital signal so as to provide the digital signal to the Win-NPA 10. Here, an analog signal is a standard signal having a real signal value of 0˜10 Vdc or 4˜20 mA.

Also, the control system hardware under validation 20 is control system hardware to be validated by using the control system performance validation apparatus and the control system performance validation method according to embodiments of the present invention. Ordinarily, the control system hardware under validation 20 receives process signals such as pressure, flowing rate, temperature, and water level signals from the nuclear power plant and provides an output to the nuclear power plant in order to control a corresponding system of the nuclear power plant. However, during performance validation, as illustrated in FIG. 1, the control system hardware under validation 20 receives a signal from the control system performance validation apparatus (the design computer code of the nuclear power plant) instead of the nuclear power plant and provides an analog output to the Win-NPA 10 in order to control a corresponding control system. Here, an analog signal is a standard signal having a real signal value of 0˜10 Vdc or 4˜20 mA.

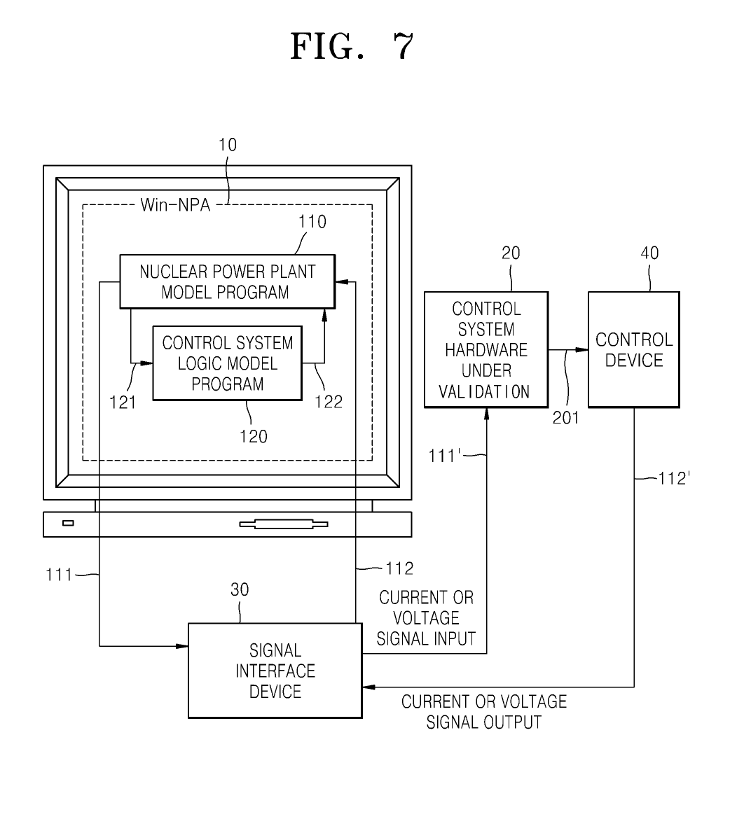

FIG. 7 is a structural diagram of a control system performance validation apparatus in relation to a control device 40, according to another embodiment of the present invention.

Referring to FIG. 7, the control system performance validation apparatus according to the current embodiment of the present invention is identical to the control system performance validation apparatus illustrated in FIG. 1. However, in FIG. 7, the control system performance validation apparatus may validate whether the control device 40 such as a valve or a pump which is connected to the control system hardware under validation 20 appropriately operates, by receiving an operation result signal of the control device 40 and using an input to a Win-NPA 10 in relation to the operation result signal. In other words, the control system performance validation apparatus may validate whether the control device 40 that is connected to the control system hardware under validation 20 appropriately operates, by receiving an operation result signal of the control device 40 and using an input to the design computer code in relation to the operation result signal.

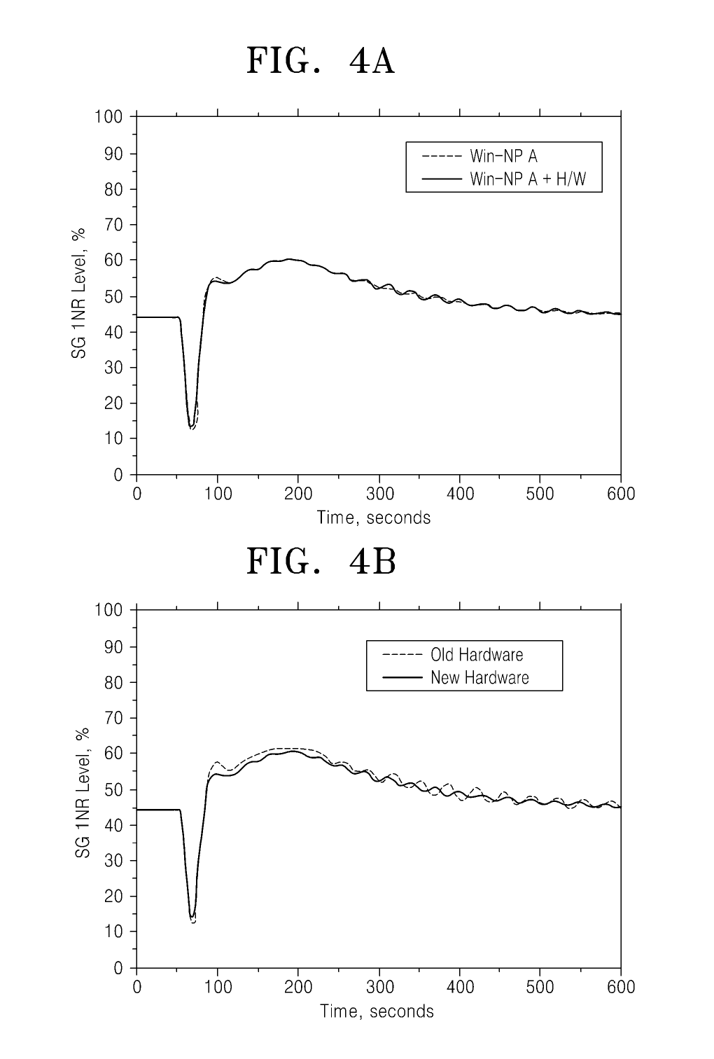

FIGS. 4A and 4B, 5A and 5B, and 6A and 6B are graphs showing results (variations in a water level of a steam generator) of performance validation tests performed on a main feedwater control system controlling the water level of the steam generator, according to embodiments of the present invention.

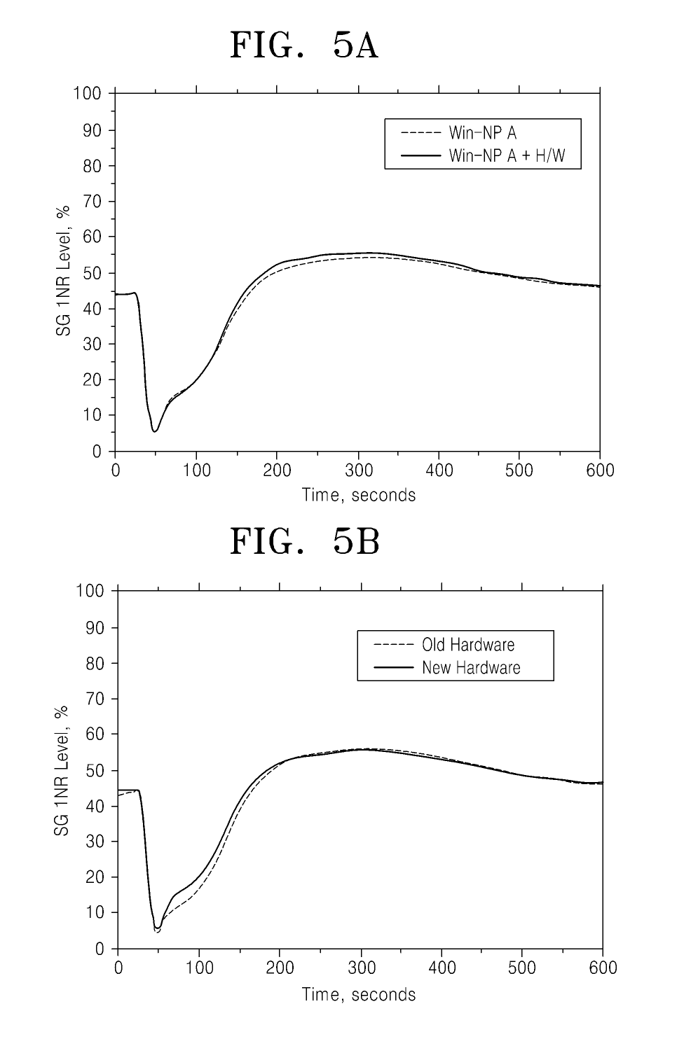

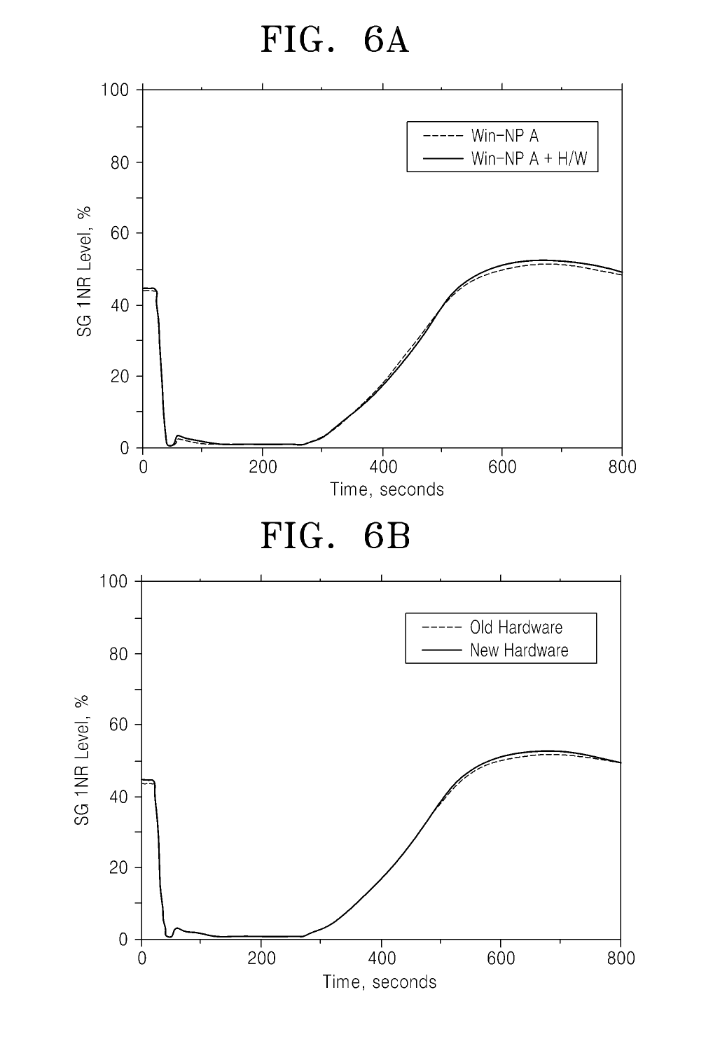

FIGS. 4A and 4B show results of performance validation tests performed when in load rejection. FIGS. 5A and 5B show results of performance validation tests performed when in loss of a main feedwater pump. FIGS. 6A and 6B show results of performance validation tests performed when in reactor trip. Each of FIGS. 4A, 5A, and 6A comparatively shows a reference simulation result obtained by using a control logic in a design computer code and a simulation result obtained by detouring the control logic in the design computer code and connecting control system hardware. Each of 4B, 5B, and 6B comparatively shows a result obtained by using old control system hardware and a result obtained by using new control system hardware.

According to the present invention, performance of a control system may be validated when a control logic of a control system is changed or hardware of the control system is replaced in a nuclear power plant in operation, and thus a related design change may be easily determined. Furthermore, a validation test of the control system may be performed at the level of a power ascension test by directly connecting a design computer code capable of simulating a transient state of the nuclear power plant to the hardware of the control system, and simulating the transient state of the nuclear power plant directly using the hardware of the control system in an on-line state. Accordingly, unlike a conventional apparatus or method, human errors during a programming process or defects of the control system due to differences in hardware characteristics may be detected, and the performance of the control system may be validated with regard to a dynamic change such as a change into the transient state, without performing the power ascension test in the nuclear power plant in operation in which the power ascension test cannot be performed. Also, by previously validating the control system in a newly built nuclear power plant before the power ascension test is performed, errors of the control system to be installed may be checked in advance and thus the power ascension test may be easily performed.

While the present invention has been particularly shown and described with reference to exemplary embodiments thereof, it will be understood by those of ordinary skill in the art that various changes in form and details may be made therein without departing from the spirit and scope of the present invention as defined by the following claims. Also, each of a design computer code and a control system logic model program according to the present invention can be implemented in the form of a computer program. In this case, the scope of the present invention includes a computer readable recording medium having recorded thereon the computer program.

What is claimed is:

1. An apparatus for validating performance of control system hardware of a nuclear power plant, the apparatus comprising an interface program inputting a signal output from a nuclear power plant model program to control system hardware under validation, inputting a signal output from the control system hardware under validation to a design computer code of the nuclear power plant, and controlling a corresponding portion of the design computer code which is related to operation of the control system hardware under validation,
wherein a performance test of the nuclear power plant is simulated by providing a simulation signal simulating the nuclear power plant to the control system hardware under validation, and reflecting an output signal of the control system hardware under validation to the simulating of the nuclear power plant, which is performed by the design computer code.

2. The apparatus of claim 1, the apparatus validates whether a control device connected to the control system hardware under validation appropriately operates, by receiving an operation result signal of the control device and using an input to the design computer code in relation to the operation result signal.

3. The apparatus of claim 1, further comprising a signal interface device comprising an analog-to-digital converter (ADC) and a digital-to-analog converter (DAC), converting a digital signal output from the design computer code into an analog signal so as to provide the analog signal to the control system hardware under validation, and converting an analog signal output from the control system hardware under validation into a digital signal so as to provide the digital signal to the design computer code.

4. The apparatus of claim 3, the apparatus validates whether a control device connected to the control system hardware under validation appropriately operates, by receiving an operation result signal of the control device and using an input to the design computer code in relation to the operation result signal.

5. The apparatus of claim 3, wherein the interface program comprises:
a design computer code control unit comprising a process variable value output controller controlling the design computer code to output a process variable value which is calculated and simulated by the design computer code, and a control system hardware under validation output signal input controller converting a signal output from the control system hardware under validation into a physical unit value, and inputting the physical unit value to a corresponding variable of the design computer code,
a signal interface control unit comprising a conversion instructor instructing the signal interface device to perform analog-to-digital (A/D) or digital-to-analog (D/A) conversion, a converter converting the process variable value in the physical unit value into a real signal value of the control system hardware under validation, and a convertor converting the real signal value of the control system hardware under validation into the physical unit value of the process variable value of the design computer code, and
a graphic user interface (GUI) manipulating constructional devices which are modeled in the design computer code.

6. The apparatus of claim 5, the apparatus validates whether a control device connected to the control system hardware under validation appropriately operates, by receiving an operation result signal of the control device and using an input to the design computer code in relation to the operation result signal.

7. A method of validating performance of control system hardware of a nuclear power plant, the method comprising:
converting a process variable value output from a design computer code of the nuclear power plant into an analog process variable signal;
transmitting the analog process variable signal to control system hardware under validation; and
converting an analog output signal which is output from the control system hardware under validation after receiving the analog process variable signal and performing a predetermined operation on the analog process variable signal, into a digital signal, and converting the digital signal into a physical unit value so as to input the physical unit value to a corresponding variable of the design computer code,
wherein a performance test of the nuclear power plant is simulated by providing a simulation signal simulating the nuclear power plant to the control system hardware under validation, and reflecting an output signal of the control system hardware under validation to the simulating of the nuclear power plant, which is performed by the design computer code.

8. The method of claim 7, further comprising validating whether a control device connected to the control system hardware under validation appropriately operates, by receiving an operation result signal of the control device and using an input to the design computer code in relation to the operation result signal.
